(19) United States
(12) Patent Application Publication
(10) Pub. No.: US 2022/0279975 A1
(43) Pub. Date: Sep. 8, 2022

(54) COOKING ARM, MEASURING METHOD, AND ATTACHMENT FOR COOKING ARM

(71) Applicant: SONY GROUP CORPORATION, TOKYO (JP)

(72) Inventors: TATSUSHI NASHIDA, TOKYO (JP); MICHAEL SIEGFRIED SPRANGER, TOKYO (JP); MASAHIRO FUJITA, TOKYO (JP)

(21) Appl. No.: 17/630,430

(22) PCT Filed: Jul. 27, 2020
(86) PCT No.: PCT/JP2020/028637

§ 371 Date: Jan. 26, 2022

(30) Foreign Application Priority Data
Aug. 8, 2019 (JP) 2019-146400

(51) Int. Cl. A47J 43/044; B25J 13/08; B25J 11/00; B25J 19/02

(52) U.S. Cl. CPC A47J 43/044; B25J 13/08; B25J 11/0045; B25J 19/02

(57) ABSTRACT

The present technique relates to a cooking arm, a measuring method, and an attachment for a cooking arm, which makes it possible to easily measure an aroma of an ingredient serving as a target of cooking. The cooking arm according to an aspect of the present technique causes a suction unit to suck an aroma of an ingredient serving as a target of a cooking operation performed by the cooking arm, and causes an aroma sensor to measure the aroma sucked by the suction unit in accordance with the cooking operation. The present technique can be applied to a system kitchen having a robot function.

### TECHNICAL FIELD

The present technique particularly relates to a cooking arm, a measuring method, and an attachment for a cooking arm, which make it possible to easily measure an aroma of an ingredient serving as a target of cooking.

### BACKGROUND ART

For a method of measuring an aroma of a food, a method such as gas chromatography using molecular analysis is generally used. Since it is a method for measuring each molecule, it takes a certain amount of time and space to measure the aroma.

Because it is difficult to perform measurements in real time, many conventional methods of measuring aromas have purposes of utilizing measured aromas later by analyzing accumulated data.

Further, in recent years, a device that can measure an aroma in a short time by adsorbing aroma-causing substances on an adsorption film having a porous structure to measure a change in weight thereof has been proposed.

### CITATION LIST

### Patent Literature

### [PTL 1]

Japanese Translation of PCT Application No. 2017-506169

### [PTL 2]

Japanese Translation of PCT Application No. 2017-536247

### SUMMARY

### Technical Problem

In the case of trying to measure an aroma of an ingredient during cooking, a person who is cooking needs to direct a device toward the ingredient to measure the aroma each time.

The present technique has been made in view of such circumstances and makes it possible to easily measure an aroma of an ingredient serving as a target of cooking.

### Solution to Problem

A cooking arm according to a first aspect of the present technique includes a suction unit configured to suck an aroma of an ingredient serving as a target of a cooking operation performed by the cooking arm, and an aroma sensor configured to measure the aroma sucked by the suction unit in accordance with the cooking operation.

An attachment for a cooking arm according to a second aspect of the present technique includes a suction unit configured to suck an aroma of an ingredient serving as a target of a cooking operation performed by the cooking arm, an aroma sensor configured to measure the aroma sucked by the suction unit in accordance with the cooking operation, and a detachable unit that is attachable to and detachable from the cooking arm.

### BRIEF DESCRIPTION OF DRAWINGS

FIG. 1 is a diagram showing a configuration example of a control system according to an embodiment of the present technique.

FIG. 2 is a diagram showing an example of described content of recipe data.

FIG. 3 is a diagram showing an example of a flow of reproduction of a dish based on the recipe data.

FIG. 4 is a diagram showing an arrangement example of a data processing device.

FIG. 5 is a perspective view showing an exterior shape of a cooking robot.

FIG. 6 is an enlarged plan view showing a state of a cooking arm.

FIG. 7 is a diagram showing an exterior shape of the cooking arm.

FIG. 8 is a diagram showing an example of a movable range of each unit of the cooking arm.

FIG. 9 is a diagram showing an example of connection between the cooking arm and a controller.

FIG. 10 is a diagram showing a state of attachment and detachment of the cooking arm.

FIG. 11 is a diagram showing an example of an internal configuration of the cooking arm.

FIG. 12 is a diagram schematically showing an internal configuration of the cooking arm.

FIG. 13 is a diagram showing another mounting example of an aroma measuring unit.

FIG. 14 is a diagram showing an example of an attachment attached to the cooking arm.

FIG. 15 is a diagram showing an example of another attachment.

FIG. 16 is a diagram showing a state of measurement of an aroma.

FIG. 17 is a diagram showing a state of measurement of an aroma.

FIG. 18 is another diagram showing a state of measurement of an aroma.

FIG. 19 is a diagram showing an example of a cooking system using an aroma measurement function of the cooking arm.

FIG. 20 is a diagram showing an example of information included in a cooking process data set.

FIG. 21 is a diagram showing an example of flavor components.

FIG. 22 is a diagram showing an example of a flow of generation of recipe data.

FIG. 23 is a diagram showing an example of a flow of reproduction of a dish based on recipe data.

FIG. 24 is a diagram showing a flow on a chef side and a flow on a reproduction side together.

FIG. 25 is a block diagram showing a configuration example of hardware of a data processing device.

FIG. 26 is a block diagram showing a functional configuration example of the data processing device.

FIG. 27 is a block diagram showing a configuration example of the cooking robot.

FIG. 28 is a flowchart illustrating processing of the data processing device.

### DESCRIPTION OF EMBODIMENTS

### <Outline of Present Technique>

The present technique is a technique in which an aroma sensor is mounted on a cooking arm of a cooking robot. In the present technique, an aroma of an ingredient serving as a target of cooking performed by the cooking arm is measured by the cooking arm.

The cooking robot is a robot that operates on the basis of recipe data and performs cooking to complete a dish. In the recipe data, for example, information about each cooking process until the dish is completed is described.

The aroma is measured by the cooking arm in conjunction with a cooking operation on the basis of the description of the recipe data. For example, the aroma is measured at a plurality of locations while the cooking arm is moved.

Also, the dish is a completed product of cooking. Cooking is a process of making a dish or an act (work) of making a dish.

In this way, the aroma measured during cooking is used for determination of whether or not the cooking by the cooking robot is performed as expected in the recipe data.

Embodiments of the present technique will be described below. Description will be given in the following order.
1. Control of cooking robot
2. Regarding measurement of aroma
3. Application example of measurement of aroma by cooking arm
4. Configuration and operation of each device
5. Other examples

### <Control of Cooking Robot>

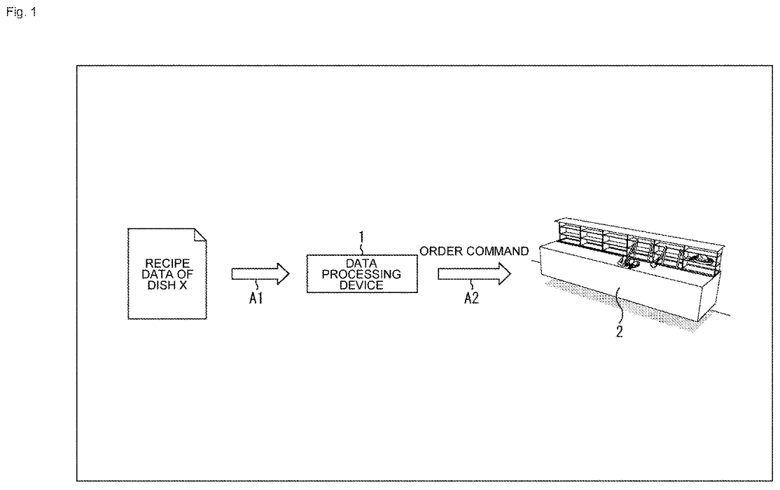

FIG. 1 is a diagram showing a configuration example of a control system according to an embodiment of the present technique.

As shown in FIG. 1, the control system includes a data processing device 1 and a cooking robot 2. The cooking robot 2 is a robot having a drive system device such as a cooking arm and various sensors, and is equipped with a function of cooking. The cooking robot 2 is installed in a household, for example.

The data processing device 1 is a device that controls the cooking robot 2. The data processing device 1 is configured of a computer or the like.

As shown at the left end of FIG. 1, control of the cooking robot 2 is performed by the data processing device 1 on the basis of recipe data prepared for each dish. Information about each cooking process is described in the recipe data.

The data processing device 1 controls the cooking robot 2 on the basis of the recipe data to prepare a dish. For example, in a case in which the recipe data of a certain dish is input as shown by an arrow A1, the data processing device 1 controls a cooking operation of the cooking robot 2 by outputting an order command on the basis of the description of the recipe data as shown by an arrow A2.

The cooking robot 2 drives each unit such as the cooking arm in accordance with the order command supplied from the data processing device 1 to perform the cooking operation of each cooking process. The order command includes information for controlling a torque, a drive direction, and a drive amount of a motor provided on the cooking arm, and the like.

Until the dish is completed, the order command is sequentially output from the data processing device 1 to the cooking robot 2. The cooking robot 2 performs an operation in response to the order command, and thus the dish is finally completed.

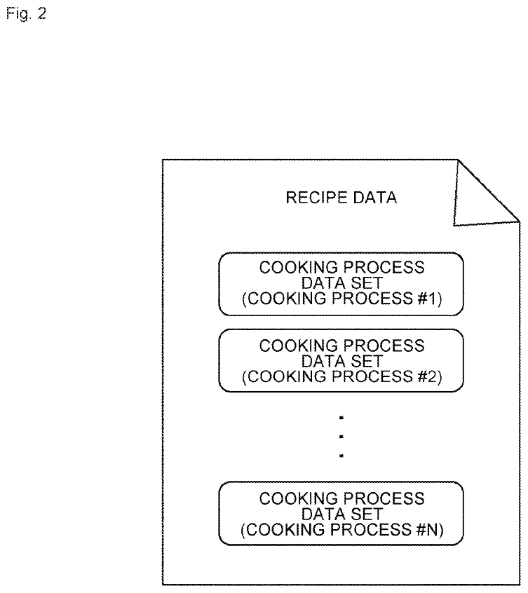

FIG. 2 is a diagram showing an example of the described content of the recipe data.

As shown in FIG. 2, one piece of recipe data is configured of a plurality of cooking process data sets. In the example of FIG. 2, a cooking process data set for cooking process #1, a cooking process data set for cooking process #2, . . . , and a cooking process data set for cooking process #N are included.

Each cooking process data set includes cooking operation information, which is information about cooking operations for realizing a cooking process. For example, one cooking process data set is configured of time-series data of cooking operation information for realizing one cooking process.

The cooking operation information includes ingredient information and operation information.

The ingredient information is information about ingredients used in the cooking process. The information about ingredients includes information indicating a type of an ingredient, an amount of an ingredient, a size of an ingredient, and the like.

Also, the ingredients include not only ingredients that have not been cooked at all, but also ingredients that have been cooked (prepared) obtained by performing a certain cooking operation. The ingredient information included in the cooking operation information of a certain cooking process includes information about ingredients that have undergone the previous cooking process.

The operation information is information about movements of the cooking arm and the like in the cooking process. The information about movements includes information indicating a type of a cooking tool used for cooking, and the like.

For example, the operation information of a cooking process of cutting a certain ingredient includes information indicating that a kitchen knife is used as a cooking tool, and information indicating a cutting position, the number of cuts, a force of cutting, an angle, a speed, and the like.

In addition, the operation information of a cooking process of stirring a pot containing a liquid serving as an ingredient includes information indicating that a ladle is used as a cooking tool, and information indicating a force of stirring, an angle, a speed, a time, and the like.

The operation information of a cooking process of baking a certain ingredient using an oven includes information indicating that the oven is used as a cooking tool, and information indicating heating power of the oven, a baking time, and the like.

The operation information of a cooking process of serving includes information on how to arrange tableware and ingredients used for serving, a color tone of ingredients, and the like.

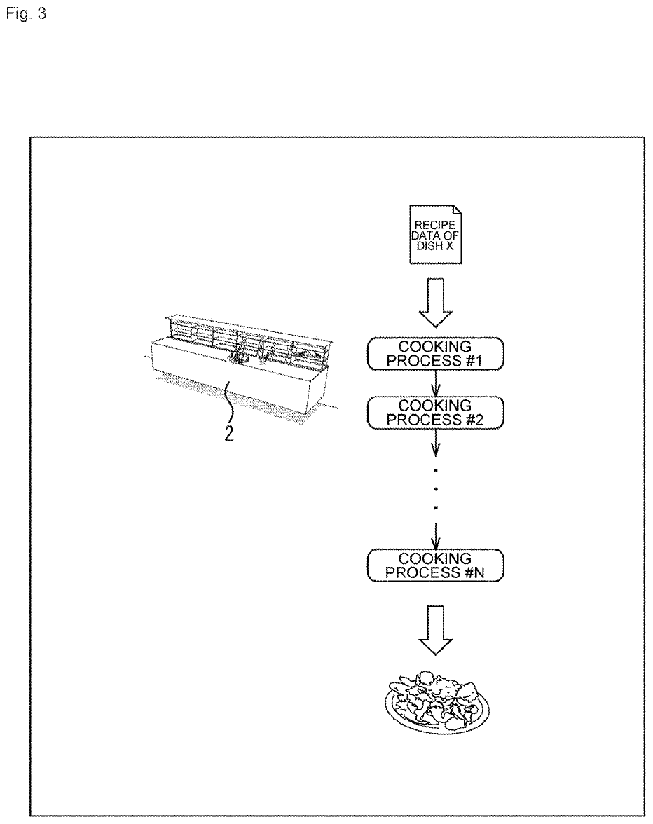

FIG. 3 is a diagram showing an example of a flow of reproduction of a dish based on recipe data.

As shown in FIG. 3, reproduction of the dish by the cooking robot 2 is performed by repeating cooking on the basis of the cooking operation information at each time included in the cooking process data set described in the recipe data for each cooking process.

For example, cooking at each time is performed by causing the cooking arm to perform an operation represented by the operation information for the ingredient represented by the ingredient information. One dish is completed through the plurality of cooking processes #1 to #N.

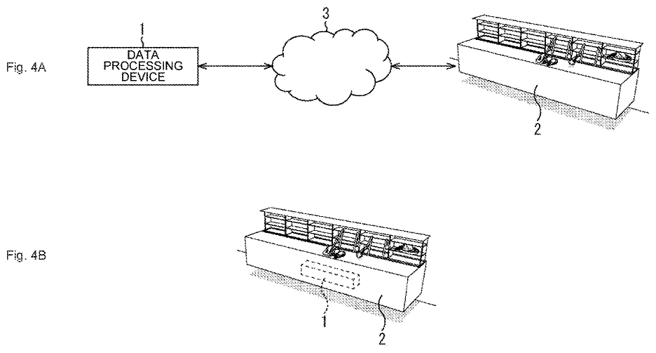

FIG. 4 is a diagram showing an arrangement example of the data processing device 1.

As shown in A of FIG. 4, the data processing device 1 is provided as, for example, an external device of the cooking robot 2. In the example of A in FIG. 4, the data processing device 1 and the cooking robot 2 are connected to each other via a network 3 such as the Internet.

The order command transmitted from the data processing device 1 is received by the cooking robot 2 via the network 3. Various data such as images captured by a camera of the cooking robot 2 and sensor data measured by sensors provided in the cooking robot 2 is transmitted from the cooking robot 2 to the data processing device 1 via the network 3.

As shown in B of FIG. 4, the data processing device 1 may be provided inside a housing of the cooking robot 2. In this case, operations of each unit of the cooking robot 2 are controlled in accordance with the order command generated by the data processing device 1.

The data processing device 1 will be mainly described below as being provided as an external device of the cooking robot 2.

### Exterior Shape of Cooking Robot

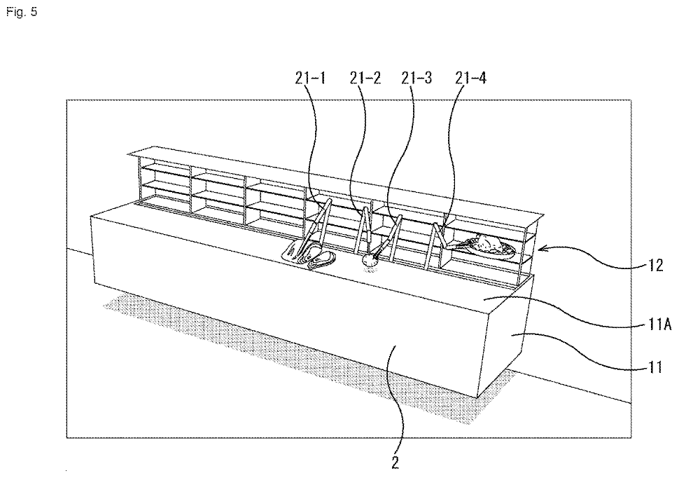

FIG. 5 is a perspective view showing an exterior shape of the cooking robot 2.

As shown in FIG. 5, the cooking robot 2 is a kitchen-type robot having a laterally elongated rectangular parallelepiped housing 11. Various configurations are provided inside the housing 11 which is a main body of the cooking robot 2.

A cooking assistance system 12 is provided on a back side of the housing 11. Each space formed in the cooking assistance system 12 by partitioning with a thin plate-shaped member has a function for assisting with cooking performed by cooking arms 21-1 to 21-4, such as a refrigerator, a microwave oven, and a storage.

A top plate 11A is provided with a rail in a longitudinal direction thereof, and the rail is provided with the cooking arms 21-1 to 21-4. The cooking arms 21-1 to 21-4 can be repositioned along the rail serving as a moving mechanism

The cooking arms 21-1 to 21-4 are robot arms configured by connecting cylindrical members with joint units. Various operations related to cooking are performed by the cooking arms 21-1 to 21-4.

A space above the top plate 11A is a cooking space in which the cooking arms 21-1 to 21-4 perform cooking.

Although four cooking arms are shown in FIG. 5, the number of cooking arms is not limited to four. Hereinafter, in a case in which it is not necessary to distinguish each of the cooking arms 21-1 to 21-4, they are collectively referred to as a cooking arm 21 as appropriate.

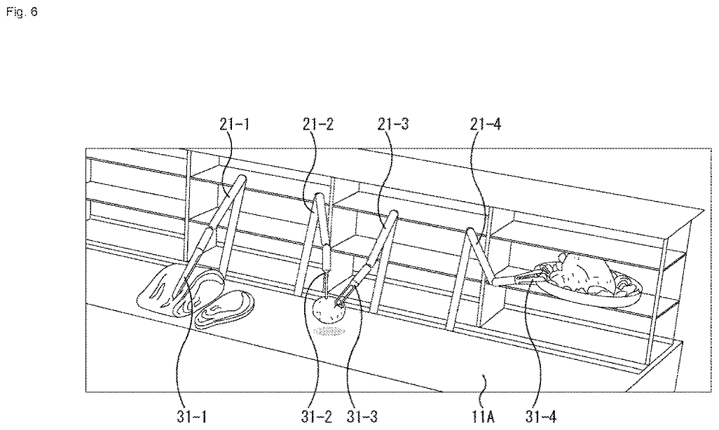

FIG. 6 is an enlarged view showing a state of the cooking arm 21.

As shown in FIG. 6, an attachment having various cooking functions is attached to a tip of the cooking arm 21. As the attachment for the cooking arm 21, various attachments such as an attachment having a manipulator function (a hand function) for grasping ingredients, tableware, or the like, or an attachment having a knife function for cutting ingredients are prepared.

In the example of FIG. 6, a knife attachment 31-1 that is an attachment having a knife function is attached to the cooking arm 21-1. A chunk of meat placed on the top plate 11A is cut using the knife attachment 31-1.

A spindle attachment 31-2, which is an attachment used to fix or rotate ingredients, is attached to the cooking arm 21-2.

A peeler attachment 31-3, which is an attachment having a function of a peeler for peeling ingredients, is attached to the cooking arm 21-3.

A potato skin lifted by the cooking arm 21-2 using the spindle attachment 31-2 is peeled by the cooking arm 21-3 using the peeler attachment 31-3. In this way, it is possible for a plurality of cooking arms 21 to cooperate with each other to perform one operation.

A manipulator attachment 31-4, which is an attachment having a manipulator function, is attached to the cooking arm 21-4. Using the manipulator attachment 31-4, a frying pan on which chicken is placed is carried to a space of the cooking assistance system 12 having an oven function.

Such cooking performed by the cooking arm 21 can proceed by appropriately replacing the attachment in accordance with content of work. It is also possible to attach the same attachment to the plurality of cooking arms 21, such as attaching the manipulator attachment 31-4 to each of the four cooking arms 21.

The cooking performed by the cooking robot 2 is performed not only by using the above attachments prepared as tools for the cooking arm, but also by appropriately using the same tools as tools used by a person for cooking. For example, a knife used by a person is grasped by the manipulator attachment 31-4, and cooking such as cutting of ingredients is performed using the knife.

### Configuration of Cooking Arm

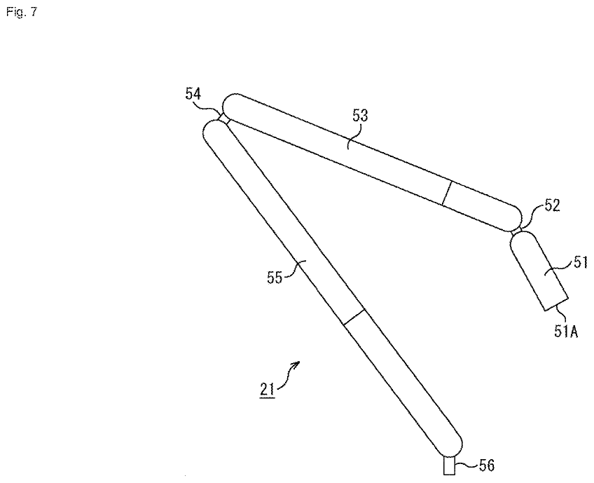

FIG. 7 is a diagram showing an exterior shape of the cooking arm 21.

As shown in FIG. 7, the cooking arm 21 is generally configured by connecting thin cylindrical members with hinge portions serving as joint units. Each hinge portion is provided with a motor or the like that generates a force for driving each member.

As the cylindrical members, a detachable member 51, a relay member 53, and a base member 55 are provided in order from the tip.

The detachable member 51 and the relay member 53 are connected by a hinge portion 52, and the relay member 53 and the base member 55 are connected by a hinge portion 54.

A detachable unit 51A to and from which an attachment is attached and detached is provided at a tip of the detachable member 51. The detachable member 51 functions as a cooking function arm unit that performs cooking by operating the attachment.

A detachable unit 56 attached to the rail is provided at a trailing end of the base member 55. The base member 55 functions as a movement function arm unit that realizes movement of the cooking arm 21.

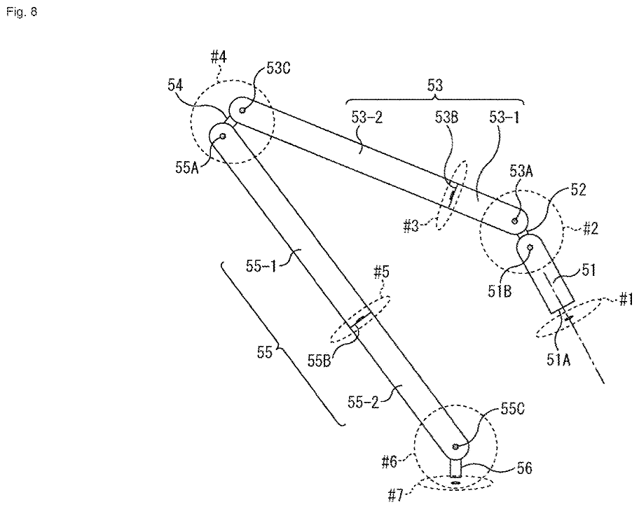

FIG. 8 is a diagram showing an example of a movable range of each unit of the cooking arm 21.

As shown surrounded with ellipse #1, the detachable member 51 is rotatable about a central axis of a circular cross-section. A small flat circle shown at the center of ellipse #1 indicates a direction of a rotation axis of a long dashed short dashed line.

As shown surrounded with circle #2, the detachable member 51 is rotatable about an axis passing through a fitting portion 51B with the hinge portion 52. Further, the relay member 53 is rotatable about an axis passing through a fitting portion 53A with the hinge portion 52.

Two small circles shown inside circle #2 indicate a direction of each rotation axis (a direction perpendicular to the paper surface). A movable range of the detachable member 51 centered on the axis passing through the fitting portion 51B and a movable range of the relay member 53 centered on the axis passing through the fitting portion 53A are, for example, 90 degrees.

The relay member 53 is configured to be separated into a member 53-1 on a leading end side thereof and a member 53-2 on a trailing end side thereof. As shown surrounded with ellipse #3, the relay member 53 is rotatable about a central axis of a circular cross-section at a connection portion 53B between the member 53-1 and the member 53-2. Other movable parts also have basically the same movable range.

As described above, the detachable member 51 having the detachable unit 51A at the tip, the relay member 53 connecting the detachable member 51 to the base member 55, and the base member 55 having a trailing end to which the detachable unit 56 is connected are rotatably connected by the hinge portions. Movements of each movable part are controlled by the controller in the cooking robot 2 in accordance with order commands.

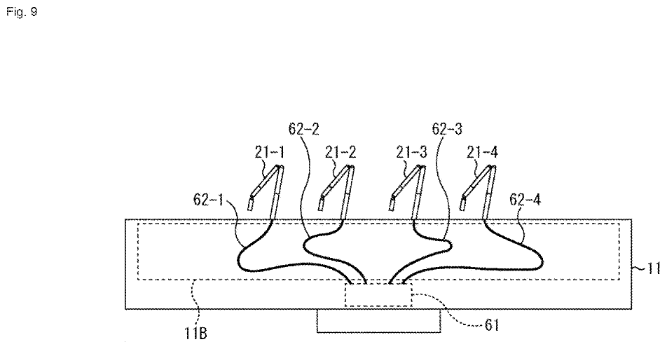

FIG. 9 is a diagram showing an example of connection between the cooking arm and the controller.

As shown in FIG. 9, the cooking arm 21 and a controller 61 are connected via a wiring in a space 11B formed inside the housing 11. In the example of FIG. 9, the cooking arms 21-1 to 21-4 and the controller 61 are connected via wirings 62-1 to 62-4. The wirings 62-1 to 62-4 having flexibility are appropriately flexed in accordance with positions of the cooking arms 21-1 to 21-4.

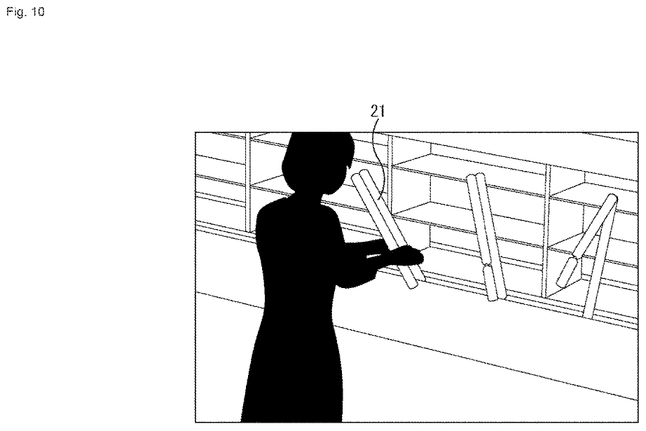

FIG. 10 is a diagram showing a state of attachment and detachment of the cooking arm 21.

As shown in FIG. 10, the cooking arm 21 is detachable from the rail provided on the top plate 11A. For example, the cooking arm 21 is sold alone. A user can make an additional purchase or the like to increase the number of the cooking arms 21.

### <Regarding Measurement of Aroma>

### Mounting Example of Aroma Sensor

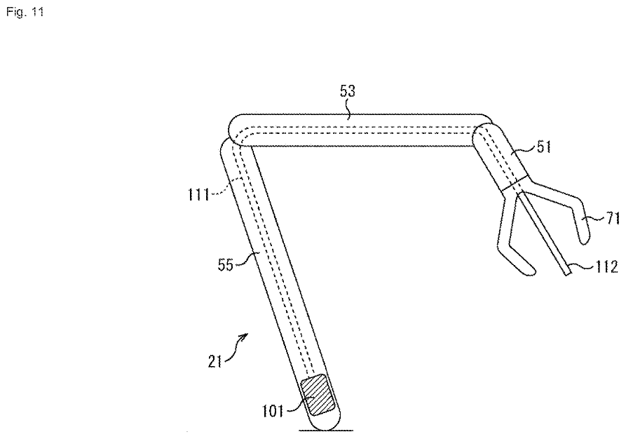

FIG. 11 is a diagram showing an example of an internal configuration of the cooking arm 21.

As shown with a hatch in FIG. 11, an aroma measuring unit 101 is provided near a root portion inside the base member 55 constituting the cooking arm 21.

A gripper attachment 71, which is an attachment having a gripper function, is attached to the cooking arm 21 shown in FIG. 11. The gripper function is a function of pinching and lifting or moving an object, similarly to the manipulator function of the manipulator attachment 31-4.

A thin rod-shaped blower pipe 112 is provided at a center of the gripper attachment 71. In the case of measuring an aroma of an ingredient during cooking, the cooking arm 21 is driven so that a tip of the blower pipe 112 comes close to an ingredient serving as a target.

As shown by a broken line, the blower pipe 112 and the aroma measuring unit 101 are connected by a pipe 111. The pipe 111 is provided to be inserted into the detachable member 51, the relay member 53, and the base member 55.

As described above, the cooking arm 21 in FIG. 11 is provided with a function of measuring aromas of ingredients and the like.

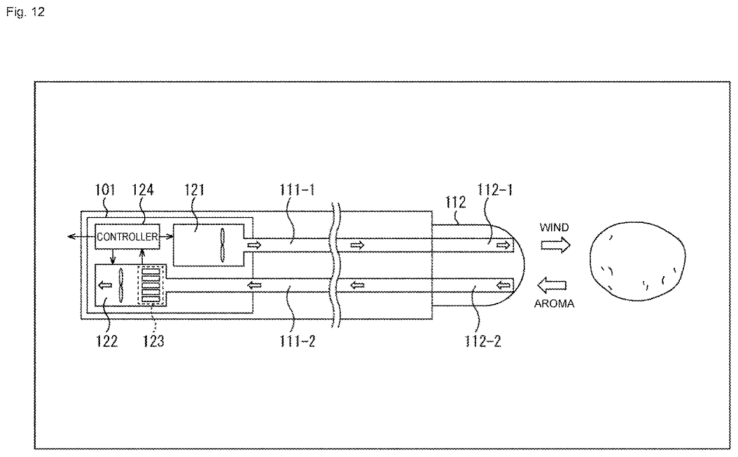

FIG. 12 is a diagram schematically showing an internal configuration of the cooking arm 21.

As shown in FIG. 12, the pipe 111 is configured of an exhaust pipe 111-1 and an intake pipe 111-2. Further, an exhaust pipe 112-1 and an intake pipe 112-2 are provided inside the blower pipe 112. In FIG. 12, illustration of the gripper attachment 71 is omitted.

A tip side of the exhaust pipe 111-1 is connected to a root side of the exhaust pipe 112-1. A tip side of the intake pipe 111-2 is also connected to a root side of the intake pipe 112-2.

The aroma measuring unit 101 is provided with a blower unit 121 and an intake unit 122.

The blower unit 121 sends a wind generated by rotating a blower fan to the exhaust pipe 111-1 as shown by a white arrow. The wind sent from the blower unit 121 is discharged from a tip of the blower pipe 112 with the inside of the exhaust pipe 111-1 and the exhaust pipe 112-1 as a flow path.

In a case in which the tip of the blower pipe 112 is close to an ingredient, the wind discharged from the blower pipe 112 hits a surface of the ingredient and generates an airflow around the ingredient. The airflow generated around the ingredient contains the aroma of the ingredient (a substance that causes the aroma).

The intake unit 122 lowers an air pressure inside the intake unit 122 by rotating an intake fan and intakes air as shown by a white arrow. The air near the tip of the blower pipe 112, including the aroma of the ingredient, is taken into the intake unit 122 through the insides of the intake pipe 112-2 and the intake pipe 111-2 as a flow path. In this way, the intake unit 122 functions as a suction unit that sucks the aroma of the ingredient.

An aroma sensor 123 is provided in the vicinity of a connection portion with the intake pipe 111-2 inside the intake unit 122. The air taken in by the intake unit 122 flows into the aroma sensor 123.

The aroma sensor 123 is a sensor that measures aroma by adsorbing an aroma-causing substance on an adsorption film having a porous structure and measuring a change in weight or electricity thereof. A signal representing results of measuring the aroma by the aroma sensor 123 is supplied to a controller 124. A sensor for measuring the aroma using another method may be provided as the aroma sensor 123.

The controller 124 provided in the aroma measuring unit 101 controls each unit of the blower unit 121, the intake unit 122, and the aroma sensor 123 in accordance with control performed by the controller 61 on the cooking robot 2 side.

For example, in a case in which it is time for the controller 124 to measure the aroma of the ingredient serving as the target of cooking, the blower unit 121 starts blowing air, and the intake unit 122 starts intake of air. Further, the controller 124 causes the aroma sensor 123 to start measuring the aroma. The recipe data also includes information indicating a timing of measuring the aroma.

The controller 124 outputs aroma data representing the results of measuring the aroma on the basis of the signal supplied from the aroma sensor 123. The aroma data output from the controller 124 is supplied to the controller 61 and transmitted from the controller 61 to the data processing device 1.

In this way, by taking in the wind blown against the ingredient, it is possible to efficiently measure the aroma of the ingredient.

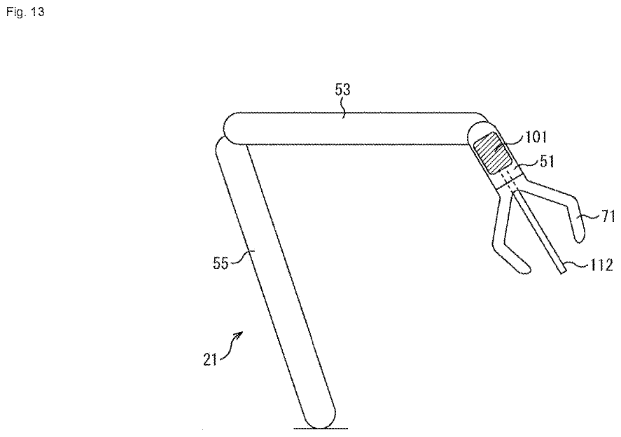

FIG. 13 is a diagram showing another mounting example of the aroma measuring unit 101.

As shown in FIG. 13, a position of the aroma measuring unit 101 can be a position other than the position near the root portion of the base member 55. In the example of FIG. 13, the aroma measuring unit 101 is provided inside the detachable member 51.

By providing the aroma measuring unit 101 inside the detachable member 51, it is possible to bring the ingredient closer to the aroma sensor 123.

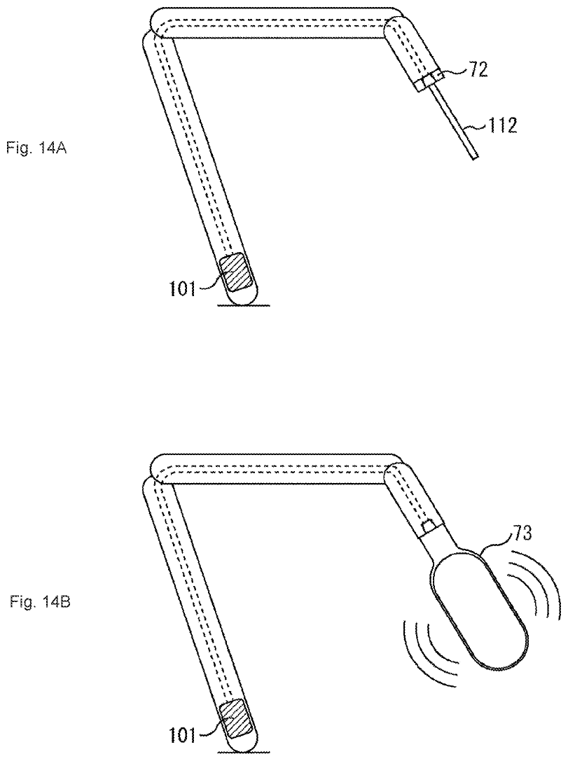

FIG. 14 is a diagram showing an example of an attachment attached to the cooking arm 21.

As shown in A of FIG. 14, the aroma may be measured using an attachment 72 provided with only the blower pipe 112, instead of the gripper type gripper attachment 71.

Further, as shown in B of FIG. 14, the aroma may be measured using a shaker type attachment 73. For example, a liquid ingredient is put in the attachment 73, and the aroma is measured for the liquid. In the case of measuring the aroma of the ingredient put in the attachment 73, the cooking arm 21 performs an operation that shakes the attachment 73.

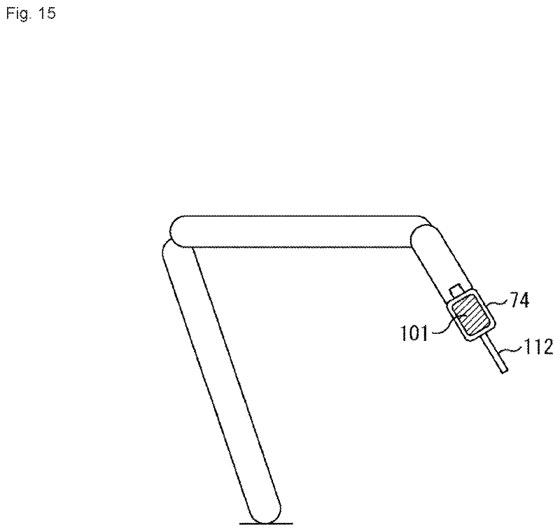

FIG. 15 is a diagram showing an example of another attachment.

An attachment 74 shown in FIG. 15 is an attachment having the aroma measuring unit 101 inside. A detachable unit that can be attached to and detached from the detachable unit 51A provided at the tip of the detachable member 51 is provided on a root side of the attachment 74.

The blower pipe 112 is attached to the aroma measuring unit 101 inside the attachment 74. In this way, the aroma measuring unit 101 may be provided on the attachment for the cooking arm 21.

For example, the attachment 74 is attached to the cooking arm 21 at a timing of measuring the aroma of the ingredient serving as the target of cooking and is used for measuring the aroma.

The blower pipe 112 may be prepared as a replaceable part for each attachment.

Thus, for example, it is possible to measure the aroma in a state in which the blower pipe 112 is in contact with the ingredient, such as the blower pipe 112 inserted into a soup in a pot. In a case in which the measurement of the aroma is completed, the pipe is replaced with a new blower pipe 112, and measurements of aromas of other ingredients or the like are performed.

### Example of Measurement of Aroma

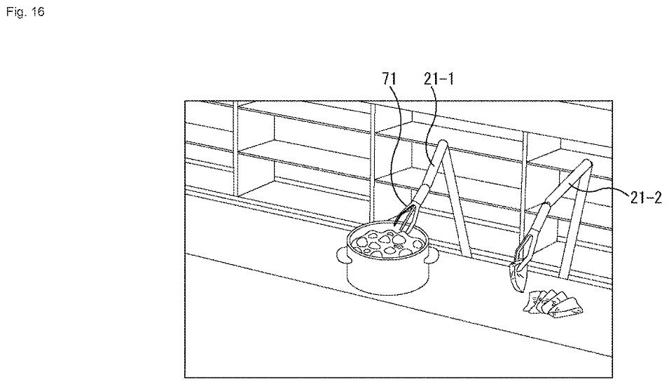

FIG. 16 is a diagram showing a state of measurement of an aroma.

In the example of FIG. 16, the measurement of the aroma is performed by the cooking arm 21-1 next to the cooking arm 21-2 performing a cooking operation. The gripper attachment 71 is attached to the cooking arm 21-1, and the tip of the blower pipe 112 is directed to a surface of a soup in a pot.

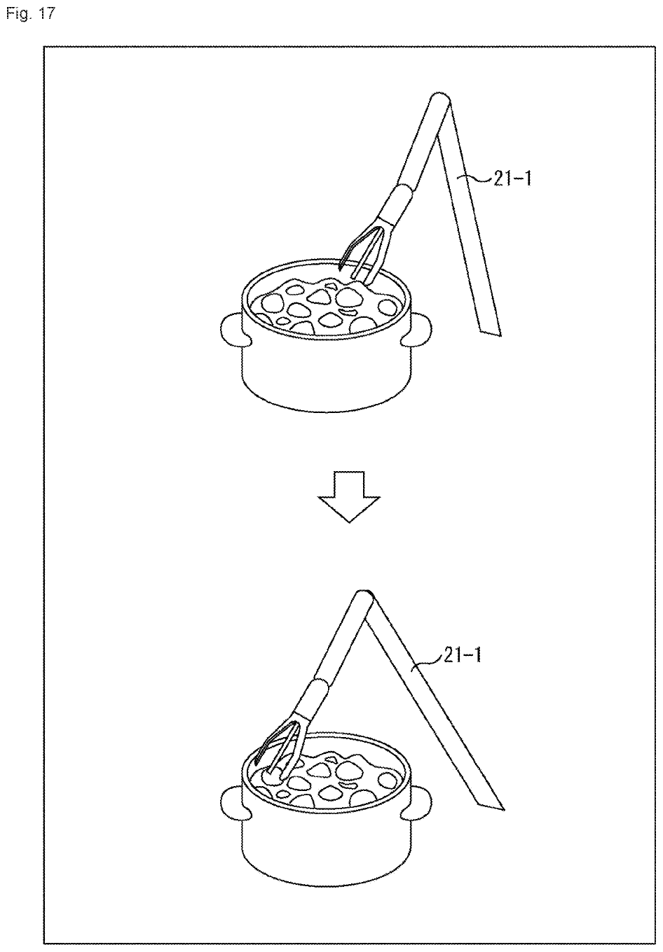

Since the tip of the blower pipe 112 can be freely moved within the movable range of the cooking arm 21-1, it is possible to switch the position and measure the aroma at a plurality of positions of the ingredient serving as the target, as shown in FIG. 17.

Also, since an operation of the other cooking arm 21 can be specified on the basis of the description of the recipe data, it is possible to measure an aroma of an ingredient obtained by the operation of the other cooking arm 21 after the operation of the other cooking arm 21 is completed without interfering with the operation of the other cooking arm 21.

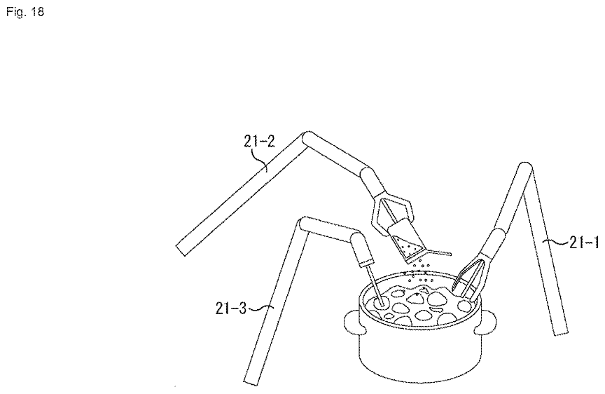

FIG. 18 is another diagram showing a state of measurement of an aroma.

Especially in the case of boiled dishes such as a stew, the aroma changes in a complicated manner depending on seasonings to be mixed. In this case, the plurality of cooking arms 21 can cooperate with each other to measure the cooking operation and the aroma.

In the example of FIG. 18, the measurement of the aroma is performed by the cooking arm 21-1, and the seasonings are added by the cooking arm 21-2. In addition, a stirring operation is performed by the cooking arm 21-3. In this way, by interlocking the plurality of cooking arms 21, it is possible to measure a change in the aroma immediately after the seasonings are mixed to generate the change in the aroma.

As described above, according to the cooking arm 21 equipped with the aroma measuring unit 101, it is possible to measure the aroma of the ingredient at an arbitrary position at an arbitrary timing.

It is said that “time” and “heat” have a great effect on an aroma in cooking. For example, in cooking such as grilling steak meat, composition of the meat changes with time and heat, which also changes the aroma.

While the meat is being grilled, the measurement of the aroma is constantly performed in real time, and measurement results are fed back to cooking operations, which enables optimal cooking on the basis of a change in the aroma.

For example, in the recipe data of steak meat, information about aroma data at each time from the start of grilling is described. In the cooking robot 2, the aroma at each time from the start of grilling is measured, and a grilling time and temperature are adjusted on the basis of whether or not the measured aroma has the aroma as described in the recipe data.

A cooking operation is performed to adjust the aroma measured by the aroma measuring unit 101 to come closer to the aroma described in the recipe data. The cooking operation for adjusting the aroma is performed until a difference between the aroma measured by the aroma measuring unit 101 and the aroma described in the recipe data becomes a difference equal to or less than a threshold.

For example, in a case in which the same aroma as the aroma that indicates a timing to end the grilling described in the recipe data is measured from the meat being cooked, the cooking ends.

In addition, the cooking of grilling steak meat includes an operation of applying seasonings such as wine, salt, and pepper. It is possible to detect a change in aroma when each seasoning is applied, and on the basis of the change in aroma, it is possible to select a type of seasoning to be applied, adjust a timing of applying the seasoning, or adjust an amount of seasoning.

Selection of the type of seasoning and adjustment of the timing and amount of seasoning may be performed on the basis of the information described in the recipe data, or may be performed on the basis of a prediction model generated in advance through deep learning or the like. In the latter case, for example, a prediction model in which aroma data measured for the meat being cooked is input, and the type of seasoning, the timing and amount of seasoning are output is prepared in the data processing device 1.

In this way, the cooking operation performed on the basis of the recipe data is appropriately adjusted on the basis of the aroma of the ingredients being cooked. This makes it possible to appropriately control the cooking operation on the basis of the aroma that cannot be determined from the exterior shape.

A temperature of the wind applied to the ingredient may be adjusted in accordance with a temperature of the ingredient serving as the target such that warm air is applied to a warm ingredient to measure the aroma, and cold air is applied to a cold ingredient to measure the aroma.

In this way, by mounting the aroma measuring unit 101 on the cooking arm 21, it is possible to easily measure the aroma of the ingredient serving as the target of cooking.

### <Application Example of Measurement of Aroma by Cooking Arm>

### Configuration of Cooking System

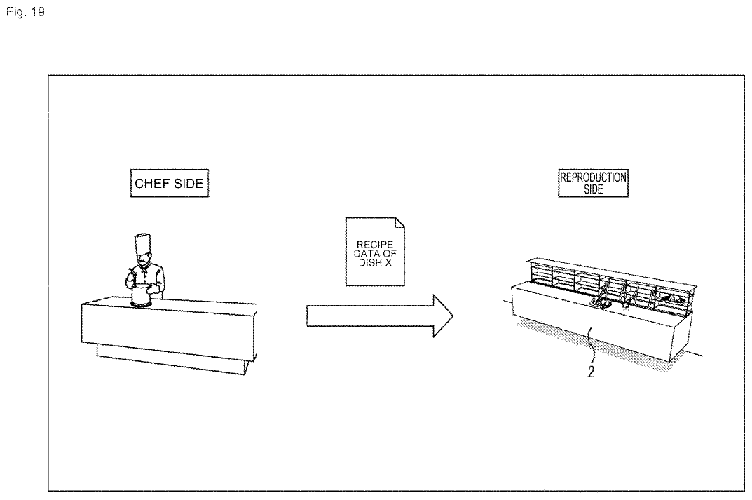

FIG. 19 is a diagram showing an example of a cooking system using an aroma measurement function by the cooking arm.

As shown in FIG. 19, the cooking system is configured of a chef side configuration for cooking and a reproduction side configuration for reproducing a dish prepared by a chef.

The chef side configuration is, for example, a configuration provided in a restaurant, and the reproduction side configuration is, for example, a configuration provided in a general household. The cooking robot 2 is prepared as the reproduction side configuration.

The cooking system in FIG. 19 is a system that reproduces the same dish as the dish prepared by the chef with the cooking robot 2 as the reproduction side configuration.

As shown by an arrow, the recipe data is provided from the chef side configuration to the reproduction side configuration including the cooking robot 2. Information about the dish prepared by the chef, including ingredients of the dish, is described in the recipe data.

In the reproduction side configuration, the dish is reproduced by controlling a cooking operation of the cooking robot 2 on the basis of the recipe data. For example, the dish is reproduced by causing the cooking robot 2 to perform the cooking operation for realizing the same process as a cooking process performed by the chef.

Although the chef is shown as a cook who performs cooking, the cooking system in FIG. 19 can be applied to a case in which any person performs cooking regardless of a name he or she is called, such as a chef, a cook, or the like, and a role he or she plays in a kitchen.

Further, in FIG. 19, only the chef side configuration of one person is shown, but a plurality of chef side configurations provided in each of a plurality of restaurants and the like may be included in the cooking system. For example, recipe data of a predetermined dish created by a predetermined chef selected by a person who eats the dish reproduced by the cooking robot 2 is provided for the reproduction side configuration.

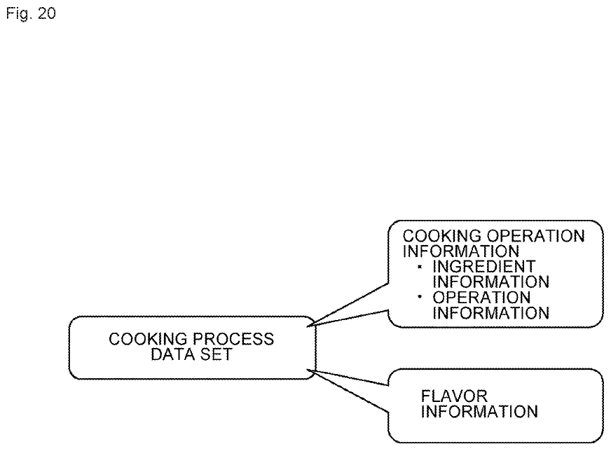

FIG. 20 is a diagram showing an example of information included in the cooking process data set.

As shown in a balloon in FIG. 20, the cooking process data set included in the recipe data (FIG. 2) includes the above-mentioned cooking operation information and flavor information which is information on flavors of ingredients used in the cooking process and ingredients that have undergone the cooking process.

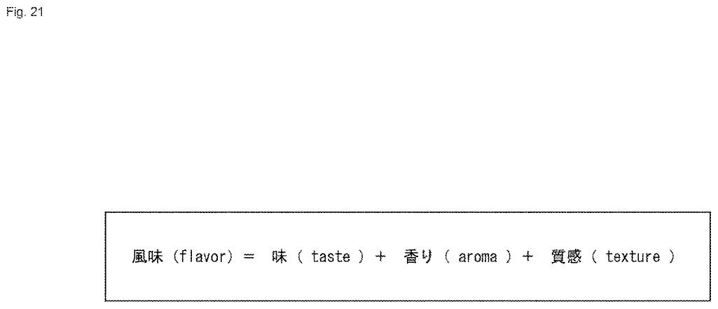

FIG. 21 is a diagram showing an example of flavor components.

As shown in FIG. 21, deliciousness that a person feels in the brain, that is, “flavor”, is mainly composed of a combination of a taste obtained by a human sense of taste, an aroma obtained by a human sense of smell, and a texture obtained by a human sense of touch.

Taste data measured by a taste measuring device, aroma data measured by a scent measuring device, texture data measured by a texture measuring device are included in the flavor information that constitutes the cooking process data set. Also, the texture includes elasticity, viscosity, a temperature, and the like of an ingredient.

In this way, the cooking process data set is configured by linking information indicating ingredients used in the cooking process and flavors of the ingredients produced through the cooking process to the cooking operation information.

Three types of data of the taste data, the aroma data, and the texture data are not prepared as the flavor information, but at least the aroma data is included in the flavor information.

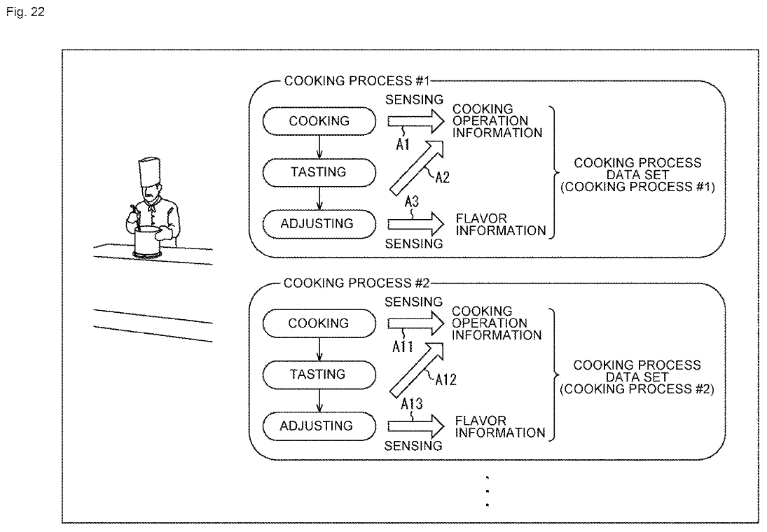

FIG. 22 is a diagram showing an example of a flow of generation of the recipe data.

As shown in FIG. 22, normally, cooking by a chef is performed by repeating a procedure of performing cooking using ingredients, tasting the ingredients after cooking, and adjusting flavor for each cooking process.

Adjustment of flavor is performed, for example, for the taste, by adding work such as adding salt in a case in which saltiness is not enough, and squeezing lemon juice in a case in which acidity is not enough. For the aroma, for example, adding work such as chopping and adding herbs, and passing ingredients through fire is performed. For the texture, for example, adding work such as tapping and softening ingredients, and increasing a boiling time in a case in which they are hard is performed.

The cooking operation information constituting the cooking process data set is generated on the basis of sensing results obtained by sensing operations of the chef who performing cooking using ingredients and operations of the chef who adjusts the flavor.

In addition, the flavor information is generated on the basis of sensing results obtained by sensing flavor of the ingredients after cooking.

In the example of FIG. 22, as shown by arrows A1 and A2, the cooking operation information that constitutes the cooking process data set of cooking process #1 is generated on the basis of sensing results of cooking operations performed by the chef as cooking process #1 and operations of the chef adjusting the flavor.

Further, as shown by an arrow A3, the flavor information constituting the cooking process data set of cooking process #1 is generated on the basis of the sensing results of the flavor of the ingredients after cooking through cooking process #1.

After cooking process #1 is completed, cooking process #2, which is the next cooking process, is performed.

Similarly, as shown by arrows A11 and A12, the cooking operation information constituting the cooking process data set of cooking process #2 is generated on the basis of the sensing results of the cooking operations performed by the chef as cooking process #2 and the operations of the chef adjusting the flavor.

Further, as shown by an arrow A13, the flavor information constituting the cooking process data set of cooking process #2 is generated on the basis of the sensing results of the flavor of the ingredients after cooking through cooking process #2.

One dish is completed through such a plurality of cooking processes. In addition, as the cooking is completed, the recipe data describing the cooking process data set of each cooking process is generated.

A case in which one cooking process is mainly configured of three cooking operations of cooking, tasting, and adjustment will be described below, but a unit of cooking operation included in one cooking process can be arbitrarily set. One cooking process may consist of cooking operations that do not involve tasting and adjustment of flavor after tasting, or may consist solely of adjustment of flavor. In this case as well, flavor sensing is performed for each cooking process, and the flavor information obtained on the basis of the sensing results is included in the cooking process data set.

The flavor sensing is not performed every time one cooking process is completed, but a timing of flavor sensing can be set arbitrarily. For example, the flavor sensing may be repeated during one cooking process. In this case, the cooking process data set includes time series data of the flavor information.

The flavor information is not included in all cooking process data sets, but each time the flavor measurement is performed at an arbitrary timing, the flavor information may be included in the cooking process data set together with the information on the cooking operations performed at that timing.

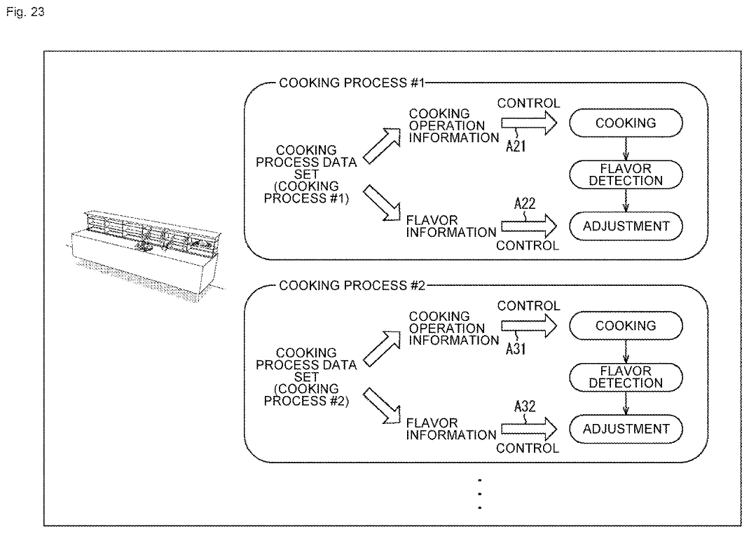

FIG. 23 is a diagram showing an example of a flow of reproduction of a dish based on the recipe data.

As shown in FIG. 23, the reproduction of the dish by the cooking robot 2 is performed by repeating a procedure of performing cooking on the basis of the cooking operation information included in the cooking process data set described in the recipe data, measuring the flavor of the ingredients after cooking, and adjusting the flavor for each cooking process.

Adjustment of flavor is performed, for example, by adding work such that the flavor measured by the sensor prepared on the cooking robot 2 side comes closer to the flavor represented by the flavor information. Details of the adjustment of flavor by the cooking robot 2 will be described later.

The measurement and adjustment of flavor may be repeated multiple times in one cooking process, for example. That is, each time the adjustment is made, the measurement of flavor is performed for the ingredient after the adjustment, and the adjustment of flavor is performed on the basis of the measurement results.

In the example of FIG. 23, as shown by an arrow A21, the cooking operation of the cooking robot 2 is controlled on the basis of the cooking operation information constituting the cooking process data set of cooking process #1, and the same operation as the operation of cooking process #1 of the chef is performed by the cooking robot 2.

After the same operation as cooking process #1 of the chef is performed by the cooking robot 2, the flavor of the ingredient after cooking is measured, and as shown by an arrow A22, the adjustment of flavor by the cooking robot 2 is controlled on the basis of the flavor information constituting the cooking process data set of cooking process #1.

In a case in which the flavor measured by the sensor prepared on the cooking robot 2 side coincides with the flavor represented by the flavor information, the adjustment of flavor is completed, and cooking process #1 is also completed. For example, in a case in which the flavor measured by the sensor prepared on the cooking robot 2 side and the flavor represented by the flavor information are not exactly the same, and a difference between both is equal to or less than a threshold, both are determined to coincide with each other.

For example, for an aroma among flavors, in a case in which the aroma measured by the aroma measuring unit 101 mounted on the cooking arm 21 coincides with the aroma represented by the flavor information, adjustment of the aroma is completed, and cooking process #1 is also completed. For example, in a case in which the aroma measured by the aroma measuring unit 101 and the aroma represented by the flavor information are not exactly the same, and a difference between both is equal to or less than a threshold, both are also determined to coincide with each other.

After cooking process #1 is completed, cooking process #2, which is the next cooking process, is performed.

Similarly, as shown by an arrow A31, the cooking operation of the cooking robot 2 is controlled on the basis of the cooking operation information constituting the cooking process data set of cooking process #2, and the same operation as the operation of cooking process #2 of the chef is performed by the cooking robot 2.

After the same operation as cooking process #2 of the chef is performed by the cooking robot 2, the flavor of the ingredients after cooking is measured, and as shown by an arrow A32, the adjustment of flavor of the cooking robot 2 is controlled on the basis of the flavor information constituting the cooking process data set of cooking process #2.

In a case in which the flavor measured by the sensor prepared on the cooking robot 2 side coincides with the flavor represented by the flavor information, the adjustment of flavor is completed, and cooking process #2 is also completed.

The cooking robot 2 reproduces the dish prepared by the chef through such a plurality of cooking processes.

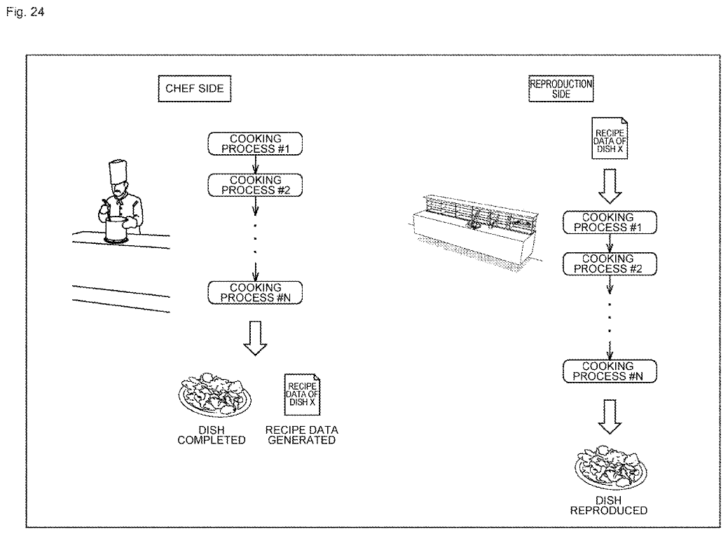

FIG. 24 is a diagram showing a flow on the chef side and a flow on the reproduction side together.

As shown on a left side of FIG. 24, one dish is completed through a plurality of cooking processes of cooking processes #1 to #N, and the recipe data describing the cooking process data set of each cooking process is generated. Further, generation of the recipe data is performed in a device such as a server that collects and analyzes the measurement results of the chefs operations.

On the other hand, on the reproduction side, one dish is reproduced through the plurality of cooking processes #1 to #N, which are the same as the cooking processes performed on the chef side, on the basis of the recipe data generated by cooking of the chef.

Since the cooking by the cooking robot 2 is performed by adjusting the flavor for each cooking process, the finally completed dish becomes a dish having the flavor that is the same as or similar to the chefs dish. In this way, the dish with the same flavor as the dish prepared by the chef is reproduced in a highly reproducible form on the basis of the recipe data.

As described above, the aroma measurement function using the aroma measuring unit 101 is used to determine each time whether or not the flavor of the ingredient obtained by the cooking operation performed at the time of reproducing the dish coincides with the flavor of the ingredient made by the chef, which is represented by the flavor information described in the recipe data.

### <Configuration and Operation of Each Device>

### Configuration of Data Processing Device 1

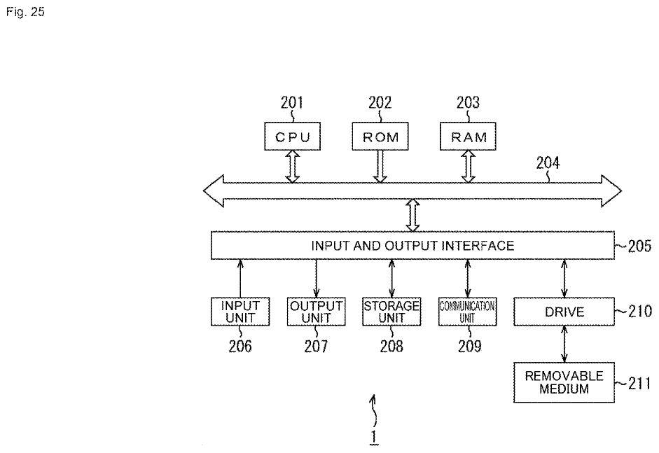

FIG. 25 is a block diagram showing a configuration example of hardware of the data processing device 1.

As shown in FIG. 25, the data processing device 1 is configured of a computer. A central processing unit (CPU) 201, a read only memory (ROM) 202, and a random access memory (RAM) 203 are connected to each other via a bus 204.

An input and output interface 205 is additionally connected to the bus 204. An input unit 206 configured of a keyboard, a mouse, and the like, and an output unit 207 configured of a display, a speaker, and the like are connected to the input and output interface 205.

In addition, a storage unit 208 configured of a hard disk, a non-volatile memory, and the like, a communication unit 209 configured of a network interface and the like, and a drive 210 for driving a removable medium 211 are connected to the input and output interface 205.

In the computer configured as above, for example, the CPU 201 loads a program stored in the storage unit 208 into the RAM 203 via the input and output interface 205 and the bus 204 and executes the program to perform various processes.

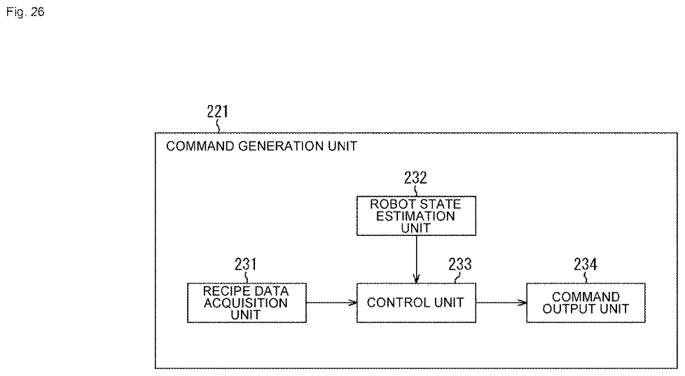

FIG. 26 is a block diagram showing a functional configuration example of the data processing device 1.

At least some of functional units shown in FIG. 26 are realized by causing the CPU 201 shown in FIG. 25 to execute a predetermined program.

As shown in FIG. 26, a command generation unit 221 is realized in the data processing device 1. The command generation unit 221 is configured of a recipe data acquisition unit 231, a robot state estimation unit 232, a control unit 233, and a command output unit 234.

The recipe data acquisition unit 231 acquires the recipe data generated by a device (not shown) by analyzing the cooking operation of the chef and outputs the recipe data to the control unit 233.

The robot state estimation unit 232 receives images and sensor data transmitted from the cooking robot 2. The images captured by the camera of the cooking robot 2 and the sensor data measured by the sensor provided at a predetermined position of the cooking robot 2 are transmitted from the cooking robot 2 at a predetermined cycle. The images captured by the camera of the cooking robot 2 show a state around the cooking robot 2.

Further, the aroma data measured by the aroma measuring unit 101 of the cooking arm 21 is transmitted from the cooking robot 2.

The robot state estimation unit 232 estimates the state around the cooking robot 2 or the state of the cooking process, such as the state of the cooking arm 21 and the state of ingredients by analyzing the images transmitted from the cooking robot 2 and the sensor data including the aroma data. Information indicating the state around the cooking robot 2 estimated by the robot state estimation unit 232 is supplied to the control unit 233.

The control unit 233 generates an order command to control the cooking robot 2 on the basis of the cooking process data set described in the recipe data supplied from the recipe data acquisition unit 231. For example, an order command for causing the cooking arm 21 to perform an operation as represented by the cooking operation information included in the cooking process data set is generated.

For generating the order command, the state around the cooking robot 2 estimated by the robot state estimation unit 232, and the like are also referred to. The order command generated by the control unit 233 is supplied to the command output unit 234.

The command output unit 234 transmits the order command generated by the control unit 233 to the cooking robot 2.

### Configuration of Cooking Robot 2

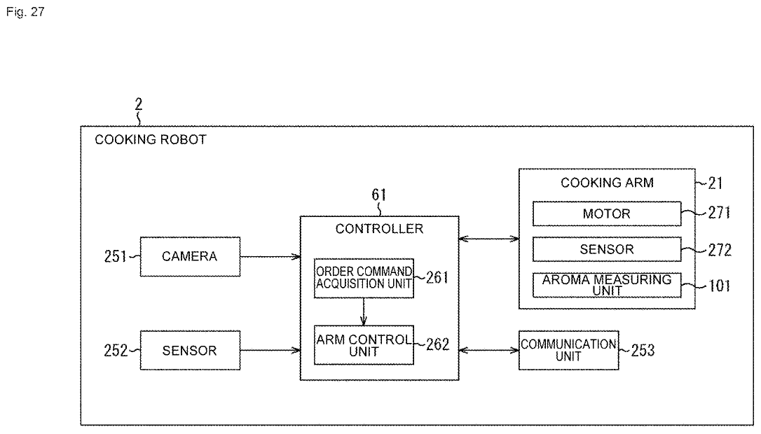

FIG. 27 is a block diagram showing a configuration example of the cooking robot 2.

The cooking robot 2 is configured by connecting each unit to the controller 61 (FIG. 9) serving as a control device for controlling the operation of the cooking robot 2. Among configurations shown in FIG. 27, the same configurations as those described above are denoted by the same reference numerals. Repeated descriptions thereof will be omitted as appropriate.

In addition to the cooking arm 21, a camera 251, a sensor 252, and a communication unit 253 are connected to the controller 61.

The controller 61 is configured of a computer having a CPU, a ROM, a RAM, a flash memory, and the like. The controller 61 causes the CPU to execute a predetermined program and controls the overall operation of the cooking robot 2. The data processing device 1 may be configured of the controller 61.

For example, the controller 61 controls the communication unit 253 and transmits images captured by the camera 251 and the sensor data measured by the sensor 252 to the data processing device 1.

In the controller 61, the order command acquisition unit 261 and the arm control unit 262 are realized by executing a predetermined program.

The order command acquisition unit 261 acquires an order command transmitted from the data processing device 1 and received by the communication unit 253. The order command acquired by the order command acquisition unit 261 is supplied to the arm control unit 262.

The arm control unit 262 controls the operation of the cooking arm 21 in accordance with the order command acquired by the order command acquisition unit 261.

The camera 251 photographs the state around the cooking robot 2 and outputs images obtained from the photographing to the controller 61. The camera 251 is provided at various positions such as in front of the cooking assistance system 12 or at a tip of the cooking arm 21.

The sensor 252 is configured of various sensors such as a temperature and humidity sensor, a pressure sensor, an optical sensor, a distance sensor, a human sensor, a positioning sensor, and a vibration sensor. Measurement by the sensor 252 is performed at a predetermined cycle. Sensor data indicating the measurement results by the sensor 252 is supplied to the controller 61.

The camera 251 and the sensor 252 may be provided at positions separated from the housing 11 of the cooking robot 2.

The communication unit 253 is a wireless communication module such as a wireless LAN module and a mobile communication module corresponding to Long Term Evolution (LTE). The communication unit 253 communicates with the data processing device 1 and an external device such as a server on the Internet.

As shown in FIG. 27, the cooking arm 21 is provided with a motor 271 and a sensor 272 in addition to the aroma measuring unit 101.

The motor 271 is provided at each joint unit of the cooking arm 21. The motor 271 rotates about an axis thereof in accordance with control performed by the arm control unit 262. An encoder for measuring an amount of rotation of the motor 271 and a driver for adaptively controlling the rotation of the motor 271 on the basis of measurement results by the encoder are also provided in each joint unit. The motor 271 functions as a drive unit for controlling the drive of the cooking arm 21.

The sensor 272 is configured of, for example, a gyro sensor, an acceleration sensor, a touch sensor, and the like. The sensor 272 measures an angular velocity, an acceleration, and the like of each joint unit during the operation of the cooking arm 21, and outputs information indicating the measurement results to the controller 61. Sensor data indicating the measurement results of the sensor 272 is also transmitted from the cooking robot 2 to the data processing device 1 as appropriate.

### Operation of Data Processing Device 1

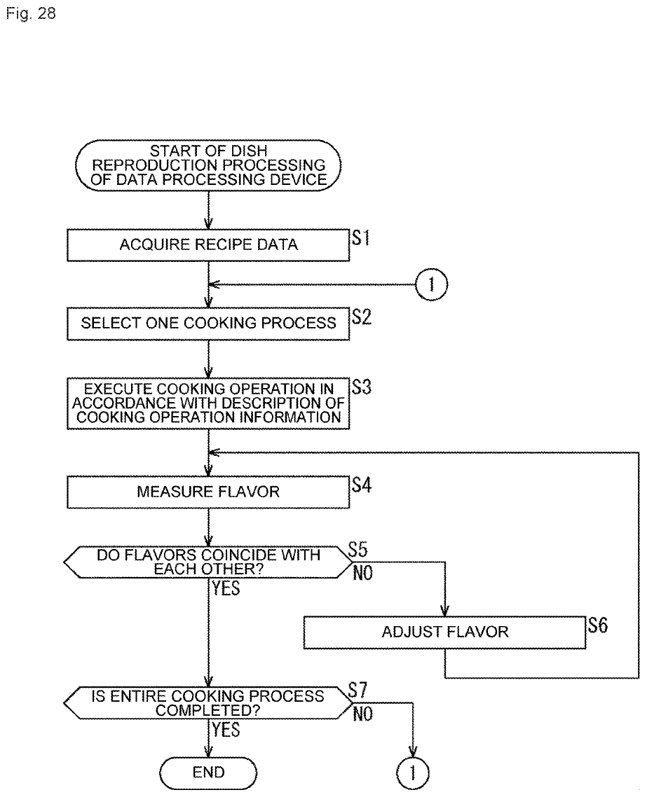

Processing of the data processing device 1 will be described with reference to a flowchart of FIG. 28. Here, adjustment of flavor will be described with a focus on adjustment of an aroma.

In step S1, the recipe data acquisition unit 231 acquires recipe data of a predetermined dish.

In step S2, the control unit 233 selects one cooking process on the basis of a cooking process data set described in the recipe data and generates an order command for performing cooking operations included in the selected cooking process. For example, the cooking process data set is selected in the order of the cooking process, and the cooking operations included in the selected cooking process are selected in the order of execution.

In step S3, the control unit 233 executes the cooking operations in accordance with description of cooking operation information. The command output unit 234 transmits the order command for executing the cooking operations to the cooking robot 2.

In step S4, the control unit 233 measures flavor of a cooked ingredient serving as a target. The command output unit 234 transmits an order command to the cooking robot 2 to drive the cooking arm 21 and measure the aroma of the ingredient.

In the cooking robot 2, the cooking arm 21 is moved in accordance with the order command and measurement of the aroma is performed by the aroma measuring unit 101. Aroma data representing the measured aroma is transmitted from the aroma measuring unit 101 to the data processing device 1.

In step S5, the control unit 233 determines whether or not flavor of the cooked ingredient and flavor represented by flavor information included in the recipe data coincide with each other. Here, in a case in which the aroma of the cooked ingredient and aroma represented by the flavor information coincide with each other, the flavors are determined to coincide with each other. In a case in which all of the taste, aroma, and texture constituting the flavor coincide with values represented by the flavor information, the flavors may be determined to coincide with each other.

In a case in which it is determined that the flavors do not coincide with each other in step S5, the control unit 233 causes the flavor to be adjusted in step S6. The command output unit 234 transmits an order command related to an operation for adjusting the aroma of the ingredient to the cooking robot 2 by driving the cooking arm 21 or the like.

Here, as described above, the adjustment of the aroma is performed by adjusting a grilling time or a temperature. In addition, the adjustment of the aroma is performed by applying a predetermined seasoning on the ingredient, adjusting a timing of applying the seasoning, and adjusting an amount of the seasoning.

After the adjustment of flavor is performed in step S6, the process returns to step S4, and the above-mentioned processes are repeatedly executed until the flavors are determined to coincide with each other.

In a case in which the flavor of the cooked ingredient and the flavor represented by the flavor information included in the recipe data are determined to coincide with each other in step S5, the process proceeds to step S7.

In step S7, the control unit 233 determines whether or not all the cooking processes have been completed, and in a case in which it is determined that all the cooking processes have not been completed, the process returns to step S2 and the above-described processing is repeated. The same processing is repeated for the next cooking process.

On the other hand, in a case in which it is determined in step S7 that all the cooking processes have been completed, the dish is completed and the reproduction process is completed.

In this way, the whole cooking proceeds while the aroma of the ingredient is adjusted on the basis of the aroma measured by the aroma measuring unit 101 of the cooking arm 21, and thus the dish having the aroma that is the same as or similar to the dish prepared by the chef can be reproduced.

### <Other Examples>

### Configuration Example of Computer

The above-mentioned series of processes can be executed by hardware or software. In a case in which the series of processes are executed by software, a program constituting the software are installed on a computer built into dedicated hardware, a general-purpose personal computer, or the like.

The installed program is recorded and provided in a removable medium 211 shown in FIG. 25, which is configured of an optical disc (a compact disc-read only memory (CD-ROM), a digital versatile disc (DVD), or the like), a semiconductor memory, or the like. In addition, the program may be provided through a wired or wireless transmission medium such as a local area network, the Internet or digital broadcasting. The program can be installed in advance in ROM 202 or the storage unit 208.

The program executed by the computer may be a program in which processing is performed in chronological order in accordance with the procedure described in the present specification or may be a program in which processing is performed in parallel or at a required timing such as when a call is made.

Also, in the present specification, the system is a set of a plurality of components (devices, modules (parts), etc.), and it does not matter whether or not all the components are in the same housing. Accordingly, both of a plurality of devices that are housed in separate housings and connected via a network, and one device in which a plurality of modules are housed in one housing are the system.

The effects described in the present specification are merely examples and are not intended as limiting, and other effects may be obtained.

The embodiments of the present technique are not limited to the above-described embodiments, and various changes can be made without departing from the gist of the present technique.

For example, the present technique can have a configuration of cloud computing in which one function is shared by a plurality of devices via a network and processed jointly.

In addition, each step described in the above flowchart can be executed by one device or shared by a plurality of devices.

Further, in a case in which one step includes a plurality of processes, the plurality of processes included in the one step can be executed by one device or shared and executed by a plurality of devices.

### REFERENCE SIGNS LIST

1 Data processing device
2 Cooking robot
21-1, 21-2, 21-3, 21-4 Cooking arm
61 Controller
101 Aroma measuring unit
121 Blower unit
122 Intake unit
123 Aroma sensor
124 Controller
221 Command generation unit
231 Recipe data acquisition unit
232 Robot state estimation unit
233 Control unit
234 Command output unit
251 Camera
252 Sensor
253 Communication unit
261 Order command acquisition unit
262 Arm control unit

1. A cooking arm comprising:
a suction unit configured to suck an aroma of an ingredient serving as a target of a cooking operation performed by the cooking arm; and
an aroma sensor configured to measure the aroma sucked by the suction unit in accordance with the cooking operation.

2. The cooking arm according to claim 1, wherein the cooking operation is performed in accordance with recipe data in which information on a cooking process is described.

3. The cooking arm according to claim 2, wherein the recipe data is data in which aroma information indicating the aroma measured with progress of cooking by a cook and cooking operation information indicating the cooking operation to be performed by the cooking arm are linked.

4. The cooking arm according to claim 3, wherein the cooking operation is executed such that the aroma measured by the aroma sensor comes closer to the aroma represented by the aroma information included in the recipe data.

5. The cooking arm according to claim 4, wherein the cooking operation is executed such that a difference between the aroma measured by the aroma sensor and the aroma represented by the aroma information included in the recipe data is equal to or less than a threshold.

6. The cooking arm according to claim 2, further comprising a control unit configured to control operations of the suction unit and the aroma sensor in accordance with the recipe data.

7. The cooking arm according to claim 6, further comprising a drive unit configured to control drive of the cooking arm in accordance with the recipe data.

8. The cooking arm according to claim 1, further comprising a blower unit configured to blow air to the ingredient in accordance with the cooking operation.

9. The cooking arm according to claim 1, wherein the aroma sensor measures the aroma on the basis of a change in electricity or weight for a gas sucked by the suction unit.

10. The cooking arm according to claim 1, comprising:
a first arm member;
a second arm member; and
a hinge portion configured to connect the first arm member to the second arm member in a rotatable state.

11. The cooking arm according to claim 10, wherein the suction unit is configured as an attachment that is attachable to and detachable from the cooking arm.

12. The cooking arm according to claim 11, wherein
the first arm member includes a detachable unit to and from which the attachment is attachable and detachable, and
the second arm member includes a detachable unit that is attachable to and detachable from an arm moving unit configured to move along a moving mechanism provided in a cooking robot.

13. A measuring method which is performed by a cooking arm, the measuring method comprising:
causing a suction unit to suck aroma of an ingredient serving as a target of a cooking operation performed by the cooking arm; and
causing an aroma sensor to measure the aroma sucked by the suction unit in accordance with the cooking operation.

14. An attachment for a cooking arm comprising:
a suction unit configured to suck an aroma of an ingredient serving as a target of a cooking operation by the cooking arm;
an aroma sensor configured to measure the aroma sucked by the suction unit in accordance with the cooking operation; and
a detachable unit that is attachable to and detachable from the cooking arm.
